(19) United States
(12) Patent Application Publication
(10) Pub. No.: US 2022/0309356 A1
(43) Pub. Date: Sep. 29, 2022

(54) WEB ELEMENTS-BASED VIRTUAL ASSISTANT FOR DISTRIBUTED APPLICATIONS

(71) Applicant: Citrix Systems, Inc., Ft. Lauderdale, FL (US)

(72) Inventor: Manbinder Pal Singh, Coral Springs, FL (US)

(73) Assignee: Citrix Systems, Inc., Ft. Lauderdale, FL (US)

(21) Appl. No.: 17/215,613

(22) Filed: Mar. 29, 2021

(51) Int. Cl. G06N 5/02; G06F 16/955; G06F 9/54; G06F 40/295; G06F 40/30

(52) U.S. Cl. CPC G06N 5/02; G06F 16/955; G06F 9/541; G06F 40/295; G06F 40/30

(57) ABSTRACT

A computing device configure to automatically generate responses to user-submitted requests is provided. The device includes a computer readable medium and a processor. The processor can be configured to perform, for example, a virtual assistant that is configured to monitor virtual assistant communications and receive a user-submitted request for additional information from a client device. In some examples, the request is submitted via a virtual assistant. The virtual assistant can be configured to process the user-submitted request to determine one or more keywords and compare the one or more keywords against at least one data set associated with the knowledge base data structure to determine at least one response to the user-submitted request. Based upon the determination of at least one response to the user-submitted request, the virtual assistant monitor can be further configured to generate a reply to the user-submitted request and transmit the reply to the client device.

### BACKGROUND

When creating focused application such as microapps, designers and/or admins generally insert various data fields related to the microapps and the data likely to be displayed in the microapp. However, occasionally, a user of a microapp may want to request additional data related to the data contained in the microapp such as more detailed information or additional related information. In such an example, the user can access a virtual assistant to submit a query for additional data.

### SUMMARY

In at least one example, a computing device for providing a response to user-submitted requests is provided. The computing device includes a computer readable medium and at least one processor operably coupled to the computer readable medium. The at least one processor is configured to receive a user-submitted request for additional information from a client device, the request submitted via a virtual assistant associated with a distributed workspace, process the user-submitted request to determine one or more user queries, process the one or more user queries using at least one data set associated with at least one application of the distributed workspace to determine at least one response to the user-submitted request, generate a reply to the user-submitted request based upon the determined at least one response, the reply generated to include one or more elements related to the determined at least one response, and transmit the reply to the client device.

Implementations of the computing device for providing a response to user-submitted requests can include one or more of the following features.

In examples of the computing device, the at least one data set can include one or more of a knowledge base data structure associated with the at least one application of the distributed workspace, a language model trained to process the user-submitted request, and/or a set of information retrieved from one or more application programming interface (API) calls associated with the at least one application of the distributed workspace. In some examples, the knowledge base data structure can include a set of named keywords, each of the set of named keywords having one or more generated questions and at least one response link related to the at least one application of the distributed workspace. In some examples, the at least one processor is can be further configured to process the user-submitted request to determine one or more keywords, compare the one or more keywords to the knowledge base data structure to identify at least one matching set of keywords, and identify the at least one response link associated with a named keyword in the at least one matching set of keywords and format the response link as the reply to the user-submitted request. In some examples, the response link comprises a uniform resource locator (URL) configured to direct a workspace application running on the client device to at least one of a second application or at least one web/SaaS application that provides additional information related to the user-submitted request.

In examples of the computing device, the at least one processor is further configured to update the knowledge base data structure based upon run-time monitoring of user interactions with the distributed workspace. In some examples, the at least one processor can be further configured to generate and/or update the knowledge base data structure based upon at least designer-provided responses to recommended information to include in the knowledge base data structure as determined by the at least one processor based upon information related to a microapp page and provided to the designer when accessing a microapp user interface builder. In some examples, the at least one processor can be further configured to auto-generate a natural language processing model based upon the knowledge base data structure. In some examples, the at least one processor can be further configured to auto-generate a question and answer model based upon the knowledge base data structure.

In examples of the computing device, the at least one processor can be further configured to process the one or more user queries by inputting the one or more user queries to the language model, receive an output to the one or more user queries from the language model, and generate the reply to the user-submitted request based upon the output of the language model.

In another example, a method of providing a response to user-submitted requests is provided. The method includes receiving, by a processor, a user-submitted request for additional information from a client device, the request submitted via a virtual assistant associated with a distributed workspace; processing, by the processor, the user-submitted request to determine one or more user queries; processing, by the processor, the one or more user queries using at least one data set associated with at least one application of the distributed workspace to determine at least one response to the user-submitted request; generating, by the processor, a reply to the user-submitted request based upon the determined at least one response, the reply generated to include one or more elements related to the determined at least one response; and transmitting, by the processor, the reply to the client device.

Implementations of the method of providing a response to user-submitted requests can include one or more of the following features.

In examples of the method, the at least one data set can include one or more of a knowledge base data structure associated with the at least one application of the distributed workspace, a language model trained to process the user-submitted request, a set of data fields assigned to a microapp associated with the at least one application of the distributed workspace when then microapp was initiated, and/or a set of information retrieved from one or more application programming interface (API) calls associated with the at least one application of the distributed workspace. In some examples, the knowledge base data structure comprises a set of named keywords, each of the set of named keywords having one or more generated questions and at least one response link related to the microapp associated with the at least one application of the distributed workspace. In some examples, the method can further include processing, by the processor, the user-submitted request to determine one or more keywords; comparing, by the processor, the one or more keywords to the knowledge base data structure to identify at least one matching set of keywords; and identifying, by the processor, the at least one response link associated with a named keyword in the at least one matching set of keywords and format the response link as the reply to the user-submitted request. In some examples, the response link can include a URL configured to direct a workspace application running on the client device to at least one of a second application or the microapp that provides additional information related to the user-submitted request.

In examples, the method can further include updating, by the processor, the knowledge base data structure based upon run-time monitoring of user interactions with the distributed workspace. In some examples, the method can further include auto-generating, by the processor, at least one of a natural language processing model based upon the knowledge base data structure and a question and answer model based upon the knowledge base data structure.

In examples, the method can further include processing, by the processor, the one or more user queries by inputting the one or more user queries to the language model; receiving, by the processor, an output to the one or more user queries from the language model; and generating, by the processor, the reply to the user-submitted request based upon the output of the language model.

In another example, a non-transitory computer-readable medium storing computer-executable instructions to implement a process of providing a response to user-submitted requests is provided. The instructions include instructions to receive a user-submitted request for additional information from a client device, the request submitted via a virtual assistant associated with a distributed workspace; process the user-submitted request to determine one or more user queries; process the one or more user queries using at least one data set associated with at least one application of the distributed workspace to determine at least one response to the user-submitted request; generate a reply to the user-submitted request based upon the determined at least one response, the reply generated to include one or more elements related to the determined at least one response; and transmit the reply to the client device.

Implementations of the non-transitory computer-readable medium storing computer-executable instructions to implement a process of providing a response to user-submitted requests can include one or more of the following features.

In examples of the non-transitory computer-readable medium, the at least one data set can include one or more of a knowledge base data structure associated with the at least one application of the distributed workspace, a language model trained to process the user-submitted request, and/or a set of information retrieved from one or more application programming interface (API) calls associated with the at least one application of the distributed workspace. In some examples, the knowledge base data structure comprises a set of named keywords, each of the set of named keywords having one or more generated questions and at least one response link related to the at least one application of the distributed workspace.

In some examples, the instructions can further includes instructions to process the user-submitted request to determine one or more keywords, compare the one or more keywords to the knowledge base data structure to identify at least one matching set of keywords, and identify the at least one response link associated with a named keyword in the at least one matching set of keywords and format the response link as the reply to the user-submitted request. In some examples, the response link can include a uniform resource locator (URL) configured to direct a workspace application running on the client device to at least one of a second application or at least one web/SaaS application that provides additional information related to the user-submitted request.

In examples of the non-transitory computer-readable medium, the instructions can further include instructions to process the one or more user queries by inputting the one or more user queries to the language model, receive an output to the one or more user queries from the language model, and generate the reply to the user-submitted request based upon the output of the language model.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a system architecture for accessing a distributed workspace by multiple client devices.

FIG. 2 is a block diagram of a virtual assistant monitor in accordance with an example of the present disclosure.

FIG. 3 is a block diagram of a sample network environment of computing device in which various aspects of the present disclosure can be implemented.

FIG. 4 is a block diagram of a cloud computing environment in which various aspects of the present disclosure can be implemented.

FIGS. 5A-5C are block diagrams of sample systems in which resource management services can manage and streamline client access to resource feeds, in accordance with an example of the present disclosure.

FIGS. 6A and 6B are screenshots of a virtual assistant interface for access by a user of a client device, in accordance with an example of the present disclosure.

FIG. 7 is a flow diagram of generating a microapp using a page builder, in accordance with an example of the present disclosure.

FIGS. 8A and 8B are flow diagrams of generating a knowledge base data structure for use when responding to a virtual assistant request, in accordance with an example of the present disclosure.

FIG. 9 illustrates a sample data structure for use when responding to a virtual assistant request, in accordance with an example of the present disclosure.

FIG. 10 is a flow diagram of processing a virtual assistant request, in accordance with an example of the present disclosure.

FIG. 11 is a block diagram of a computing device that can implement one or more of the computing devices of FIGS. 1, 3, 4, and/or 5A-5C, in accordance with at least one example of the present disclosure.

### DETAILED DESCRIPTION

As summarized above, various examples described herein are directed to systems and methods for providing answers to user requests submitted via a virtual assistant when the user is interacting with a microapp or other similarly limited application. For example, the systems and methods as described herein include a virtual assistant monitor that monitors user interaction with a virtual assistant to determine whether a user has submitted a request for additional information via the virtual assistant. The virtual assistant monitor can be configured to query several sources of application information to identify an answer to the user request and provide the appropriate answer back to the user. For example, the sources of additional information can include application programming interfaces (APIs), dynamically updated knowledge base data structures, microapp tags and data fields, and other similar sources of information.

A client device as described herein can include a workspace application that is configured to include a virtual assistant interface. A user of the client device can enter a request into the virtual assistant interface and receive a response from the virtual assistant monitor as described herein. However, unlike the static and limited sources of information associated with microapps that a virtual assistant may have been able to access in other systems, the present disclosure further teaches providing dynamic and updated sources of information from which to determine a response to a user-submitted request.

Such systems and methods as described herein provide various advantages to improve a user's experiences when using microapps or other similar limited applications. For example, when using a microapp, a user may request additional information or features that are available in full web applications associated with the microapp but not available in the microapp itself. In such an example, the systems and methods as described herein can provide additional information related to the full application to the user via the virtual assistant. Similarly, legacy applications may have limited functionality and/or no APIs. As such, a traditional virtual assistant may be unable to answer a question related to the legacy application that is not explicitly pre-defined for the application. Using the systems and methods as described herein, knowledge base data structures can be created for the legacy applications to provide a user with information about additional functionality associated with the legacy application. Additionally, using the systems and methods as described herein, a user can provide a request in a natural language format and expect to receive an answer in a similar natural language format from, for example, a legacy application that does not include such functionality, thereby increasing the overall usefulness of a virtual assistant as described herein.

Thus, and in accordance with at least some examples disclosed herein, systems and methods for providing virtual assistant monitoring and responses to requests are provided. In some examples, the methods and systems include improved interaction and response generation for responding to a user-submitted request. These systems and methods enhance the quality of a user's experience by increasing the availability of automatically generated and fully responsive replies to user-submitted requests as a user interacts with a virtual assistant in a distributed workspace as defined herein.

In some examples, a computing device configure to automatically generate responses to user-submitted requests is provided. The computing device includes a computer readable medium and at least one processor operably coupled to the computer readable medium. The processor can be configured to perform, for example, a virtual assistant that is configured to monitor virtual assistant communications and receive a user-submitted request for additional information from a client device. In some examples, the request is submitted via a virtual assistant. The virtual assistant can be further configured to process the user-submitted request to determine one or more keywords and compare the one or more keywords against at least one data set associated with the knowledge base data structure to determine at least one response to the user-submitted request. Based upon the determination of at least one response to the user-submitted request, the virtual assistant monitor can be further configured to generate a reply to the user-submitted request and transmit the reply to the client device.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Sample Computing Systems

In some examples, a distributed system is configured to implement workspace and system access to remote users, thereby providing a central repository of applications, files, and other similar resources to a group of trusted users accessible via, for example, an enterprise service. A digital workspace can be implemented as a software framework designed to deliver and manage a user's applications, data, and desktops in a consistent and secure manner, regardless of the user's device or location. Digital workspaces enhance the user experience by streamlining and automating those tasks that a user performs frequently, such as approving expense reports, confirming calendar appointments, submitting helpdesk tickets, and reviewing vacation requests. A digital workspace allows users to access functionality provided by multiple enterprise applications—including software as a system (SaaS) applications, web applications, desktop applications, and proprietary applications—through a single interface.

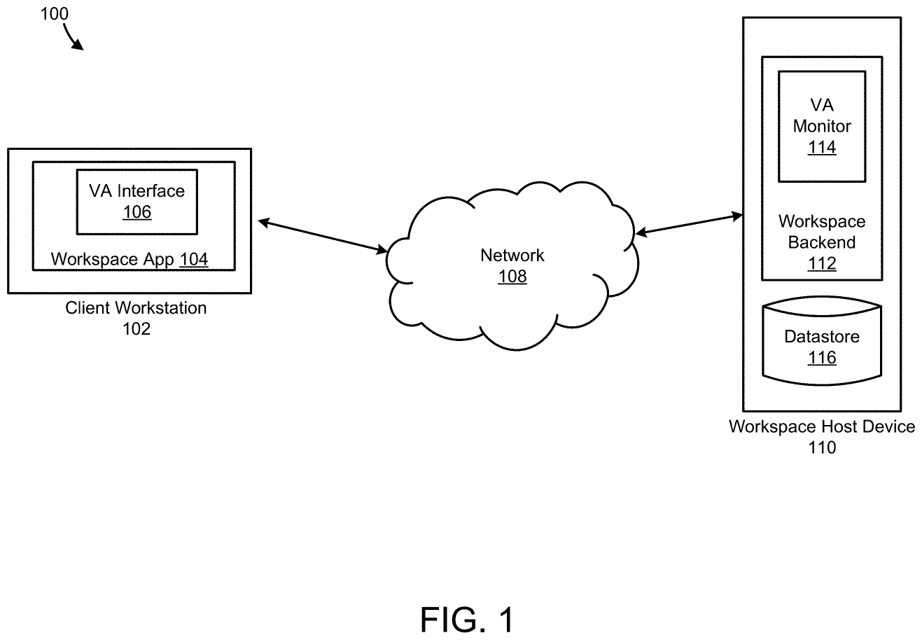

FIG. 1 illustrates a logical architecture of one implementation of, for example, a distributed workspace system 100 that is configured to connect one or more client computing devices with one or more remote computing devices configured to host shared resources such as applications accessible via the distributed workspace. As shown in FIG. 1, the system 100 can include a client device 102. As further shown in FIG. 1, client devices 102 can include a workspace application 104. The workspace application 104 can be configured to provide an interface to facilitate remote access to one or more resources hosted at or by, for example, a remote computing device such as workspace host device 110. In certain implementations, the client device 102 can be operably connected to the remote computing device via one or more networks 108. In some examples, the network 108 can be a wired network, a wireless network, or a combination of both wired and wireless networks.

In some examples, the workspace host device 110 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol (HTTP) client; a File Transfer Protocol (FTP) client; an Oscar client; a Telnet client; or any other set of executable instructions.

In some examples, the workspace host device 110 can execute a remote presentation services program or other program that uses a thin client or a remote-display protocol to capture display output generated by an application executing on the remote computing device and transmit the application display output to the client device 102 for presentation to one or more device users.

In some examples, the workspace host device 110 can include a server agent that is configured to communicate with the workspace application 104. The server agent can be configured to, for example, authenticate a client device, provide secure access to one or more remote and/or shared resources, monitor user interactions with the resources, update user access based upon changes to user permission levels for a client device, distribute or properly direct requests to available resources, and perform other similar distributed workspace functions.

In yet other examples, the workspace host device 110 can be configured to execute a virtual machine providing access to a computing environment to a user of client device 102. The virtual machine can be managed by, for example, a hypervisor, a virtual machine manager (VMM), or any other hardware virtualization technique within the workspace host device 110.

In some examples, the network 108 can be: a local area network (LAN); a metropolitan area network (MAN); a wide area network (WAN); a primary public network; and a primary private network. Additional examples can include a network 108 of mobile telephone networks that use various protocols to communicate among mobile devices. For short range communications within a wireless local-area network (WLAN), the protocols can include 802.11, Bluetooth, and Near Field Communication (NFC).

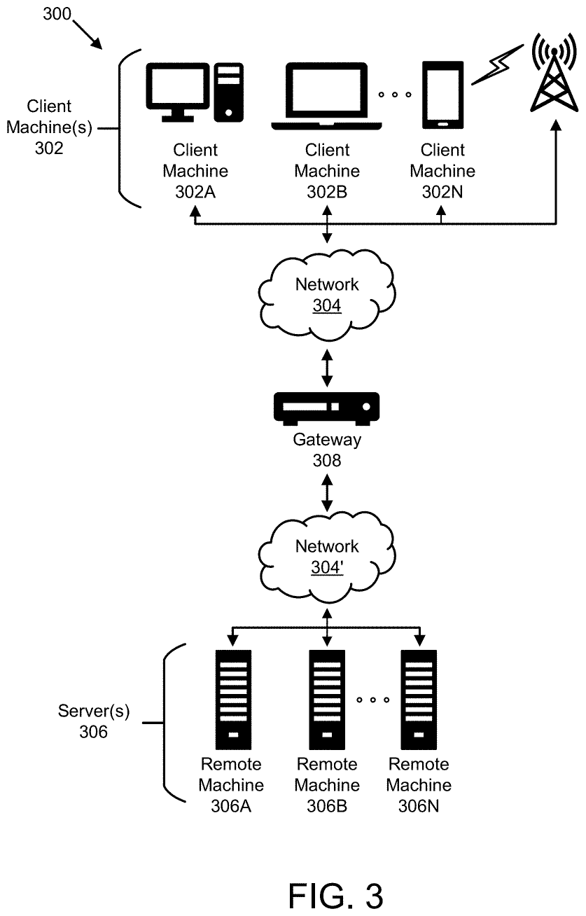

It should be noted that the specific device architecture as shown in FIG. 1 is provided by way of example only. For instance, in certain implementations, multiple remote computing devices can be operably connected to the client devices via, for example, one or more network appliances configured to perform, for example, access control and load balancing. Additional network examples and associated devices are described below in the discussion of FIG. 3.

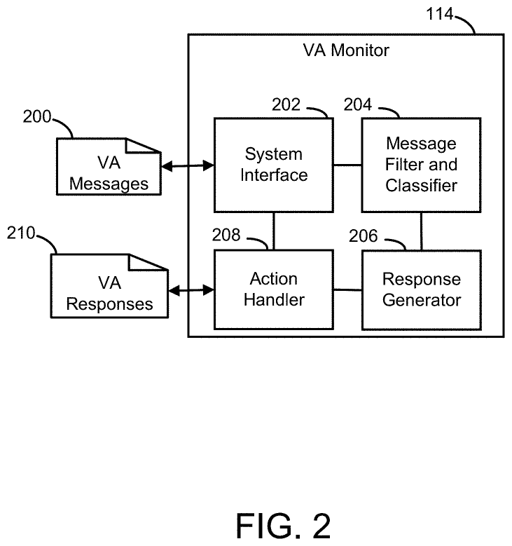

In a typical distributed workspace, a user of the client device 102 can access a virtual assistant interface 106 through, for example, workspace application 104. For example, the user can enter a query or other similar request in the virtual assistant interface 106. The request can be processed by the workspace application 104 and transmitted to a workspace backend 112 on the workspace host device 110. The workspace backend 112 can include a virtual assistant monitor 114 configured to receive and process any requests received form the workspace application 104. For example, the virtual assistant request can include a request for additional information related to a specific application. The virtual assistant monitor 114 can process the request and, if present, retrieve information related to the request from a specific location such as datastore 116. Additional information related to processing virtual assistant requests is provided in the following discussion of FIGS. 2-10.

As noted above, to process virtual assistant queries and requests as described herein, a monitoring component such as the virtual assistant monitor 114 as shown in FIG. 1 and described above can be configured to monitor for and process virtual assistant requests. As shown in FIG. 2, the virtual assistant monitor 114 of workspace host device 110 as shown in FIG. 1 can include a system interface 202, a message filter and classifier 204, a response generator 206, and an action handler 208. In some examples, the system interface 202 can be configured to interoperate with various components by exchanging messages 200 with the components. These components can include, for example, a virtual assistant interface (e.g., VA interface 106 of FIG. 1), a workspace application (e.g., workspace application 104 of FIG. 1) and/or a workspace backend (e.g., workspace backend 112 of FIG. 1). The messages 200 can include the virtual assistant queries and/or requests data (e.g., text or other data entered by a user of the client device 102 into the virtual assistant interface 106). The system interface 202 is configured to enable the virtual assistant monitor 114 to interoperate with these various components. As such, the system interface 202 can expose and implement an API and/or transmit and receive messages that conform with the APIs or interfaces of other components.

For instance, in some examples, the system interface 202 can be configured to interoperate with a gateway process or a monitored application to request and receive hypertext markup language (HTML) encoded documents, which constitute a description of at least a portion of the information received from the virtual assistant interface.

In some examples, the message filter and classifier 204 can be configured to receive the message data from the system interface 202 and determine a classification of one or more words contained within the message data. For example, the message filter and classifier can include a natural language processor configured to identify one or more words in the message data and identify, for example, a part of speech of each identified word. In some examples, the message filter and classifier 204 can be configured to provide the filtered and classified words to the response generator 206 for further processing.

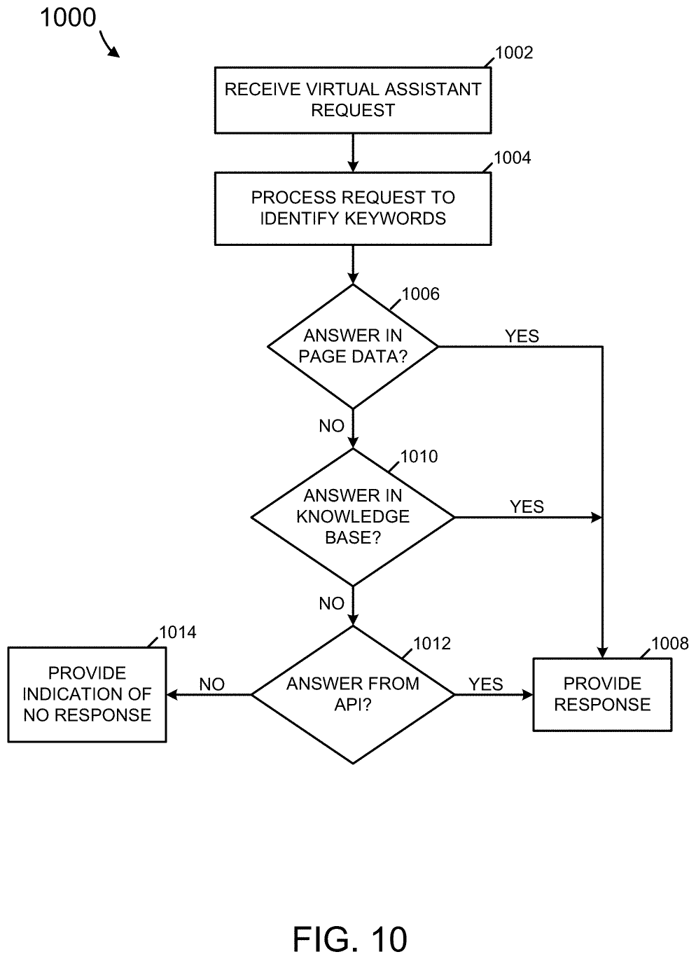

In some examples, the response generator 206 can be configured to process the filtered and classified words to determine whether a response to the virtual assistant request can be determined. If the response generator 206 can generate a response, the response generator can determine a response and format the response accordingly. If, conversely, the response generator 206 cannot generate a response, the response generator can generate an indication providing feedback indicating that no response is available. Additional detail related to generating a response to a virtual assistant request is provided below in, for example, the discussion of FIG. 10.

In some examples, the action handler 208 can be configured to perform various functions in response to information received from the response generator 206. For example, if the response generator 206 provides a response to the virtual assistant request, the action handler can perform any necessary formatting to the response and transmit the response 210 to, for example, the workspace backend 112 of FIG. 1 for further processing and transmission to the client device 102. In some examples, the action handler 208 can be configured to format the response and provide the formatted response to the system interface for transmission. In some examples, the action handler 208, or a portion thereof, is hosted remotely from the other processes illustrated within the VA monitor 114 of FIG. 2.

It should be noted that the components and process for processing virtual assistant requests as shown in FIG. 2 and described above are provided by way of example only. Additional detail related to receiving and processing a virtual assistant request is provided below in, for example, the discussion of FIG. 10.

As noted above in FIG. 1, various computing devices can be arranged into one or more interconnected networks to provide user access to remote resources through various client devices. Referring to FIG. 3, a non-limiting network environment 300 provides an alternative arrangement to network 100 as shown in FIG. 1, in which various aspects of the disclosure can be implemented includes one or more client machines 302A-302N, one or more remote machines 306A-306N, one or more networks 304, 304′, and one or more appliances 308 installed within the computing environment 300. The client machines 302A-302N communicate with the remote machines 306A-306N via the networks 304, 304′. The computing environment 300 can also be referred to as a distributed computer system.

In some examples, the client machines 302A-302N communicate with the remote machines 306A-306N via an intermediary appliance 308. The illustrated appliance 308 is positioned between the networks 304, 304′ and can also be referred to as a network interface or gateway. In some examples, the appliance 308 can operate as remote computing device configured to provide clients with access to business applications and other data deployed in a datacenter, the cloud, or delivered as SaaS applications across a range of client devices, and/or provide other functionality such as load balancing, etc. In some examples, multiple appliances 308 can be used, and the appliance(s) 308 can be deployed as part of the network 304 and/or 304′.

The client machines 302A-302N can be generally referred to as client machines 302, local machines 302, clients 302, client nodes 302, client computers 302, client devices 302, computing devices 302, endpoints 302, or endpoint nodes 302. In certain implementations, client machines 302 can include, for example, client device 102 as shown in FIG. 1 and described above.

The remote machines 306A-306N can be generally referred to as servers 306 or a server farm 306. In some examples, a client device 302 can have the capacity to function as both a client node seeking access to resources provided by a server 306 and as a server 306 providing access to hosted resources for other client devices 302A-302N. The networks 304, 304′ can be generally referred to as a network 304. The networks 304 can be configured in any combination of wired and wireless networks.

A server 306 can be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality. In some examples, a server 306 can include the functionality of the workspace host device 110 as shown in FIG. 1 and described above.

A server 306 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol client; a File Transfer Protocol client; an Oscar client; a Telnet client; or any other set of executable instructions.

In some examples, a server 306 can execute a remote presentation services program or other program that uses a thin client or a remote-display protocol to capture display output generated by an application executing on a server 306 and transmit the application display output to a client device 302.

In yet other examples, a server 306 can execute a virtual machine providing, to a user of a client device 302, access to a computing environment. The client device 302 can be a virtual machine. The virtual machine can be managed by, for example, a hypervisor, a virtual machine manager (VMM), or any other hardware virtualization technique within the server 306.

In some examples, the network 304 can be: a LAN; a MAN; a WAN; a primary public network; and a primary private network. Additional examples can include a network 304 of mobile telephone networks that use various protocols to communicate among mobile devices. For short range communications within a WLAN, the protocols can include 802.11, Bluetooth, and NFC. In certain examples, the network 304 can include network 108 as shown in FIG. 1 and described above.

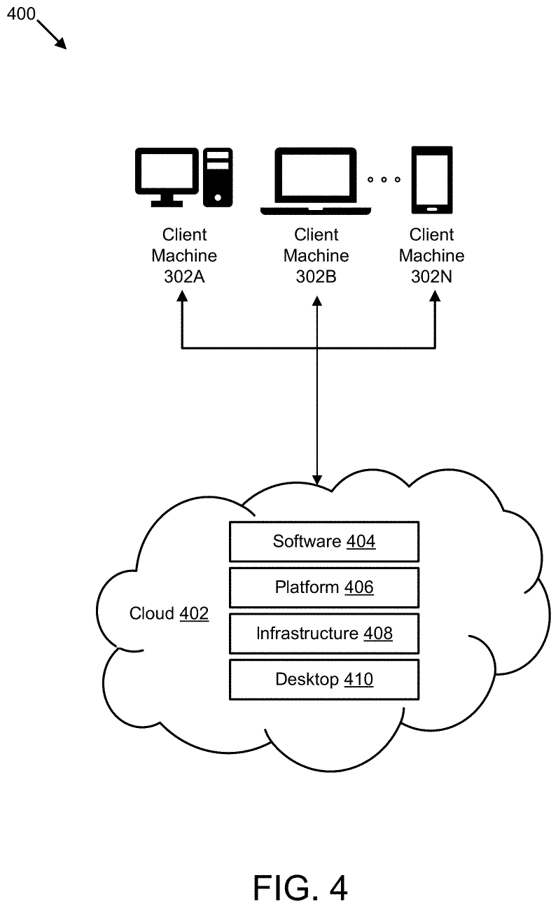

Referring to FIG. 4, a cloud computing environment 400 is depicted, which can also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 302a-302n (such as those described above and shown in FIG. 3) are in communication with a cloud network 402. The cloud network 402 can include back-end platforms, e.g., servers, storage, server farms or data centers. The users or clients 302a-302n can correspond to a single organization/tenant or multiple organizations/tenants. More particularly, in one example implementation the cloud computing environment 400 can provide a private cloud serving a single organization (e.g., enterprise cloud). In another example, the cloud computing environment 400 can provide a community or public cloud serving multiple organizations/tenants.

In some examples, a gateway appliance(s) or service can be utilized to provide access to cloud computing resources and virtual sessions. By way of example, Citrix Gateway, provided by Citrix Systems, Inc., can be deployed on-premises or on public clouds to provide users with secure access and single sign-on to virtual, SaaS and web applications. Furthermore, to protect users from web threats, a gateway such as Citrix Secure Web Gateway can be used. Citrix Secure Web Gateway uses a cloud-based service and a local cache to check for uniform resource locator (URL) reputation and category.

In still further examples, the cloud computing environment 400 can provide a hybrid cloud that is a combination of a public cloud and a private cloud. Public clouds can include public servers that are maintained by third parties to the clients 302a-302n or the enterprise/tenant. The servers can be located off-site in remote geographical locations or otherwise.

The cloud computing environment 400 can provide resource pooling to serve multiple users via clients 302a-302n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some implementations, the cloud computing environment 400 can provide on-demand self-service to unilaterally provision computing capabilities (e.g., server time, network storage) across a network for multiple clients 302a-302n. By way of example, provisioning services can be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 302. In some examples, the cloud computing environment 400 can include or provide monitoring services to monitor, control and/or generate reports corresponding to the provided shared services and resources.

In some implementations, the cloud computing environment 400 can provide cloud-based delivery of different types of cloud computing services, such as SaaS 404, Platform as a Service (PaaS) 406, Infrastructure as a Service (IaaS) 408, and Desktop as a Service (DaaS) 410, for example. IaaS can refer to a user renting the use of infrastructure resources that are needed during a specified time period. IaaS providers can offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers can offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers can offer the resources that PaaS provides, including storage, networking, servers, virtualization, operating system, middleware, or runtime resources. In some examples, SaaS providers can offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS can also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms can be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace application can be used as a single-entry point for bringing apps, files and desktops together (whether on-premises or in the cloud) to deliver a unified experience.

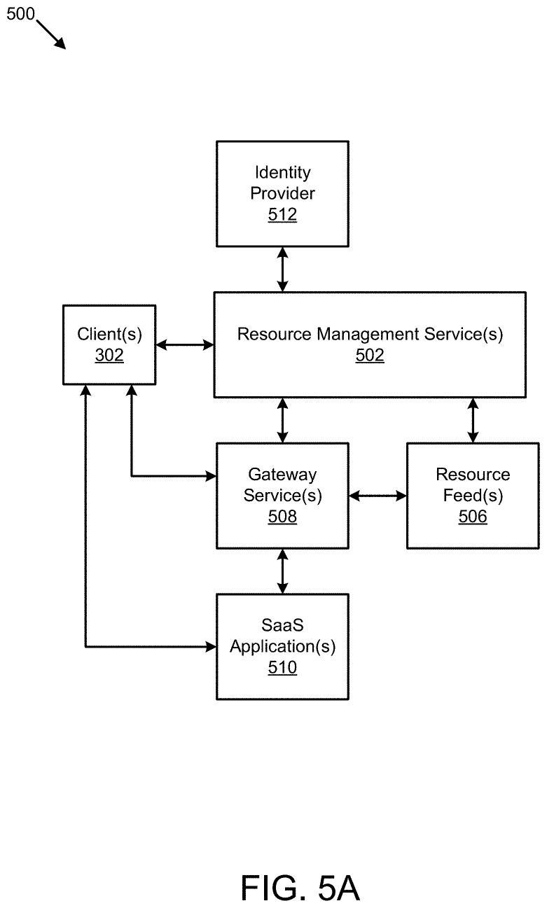

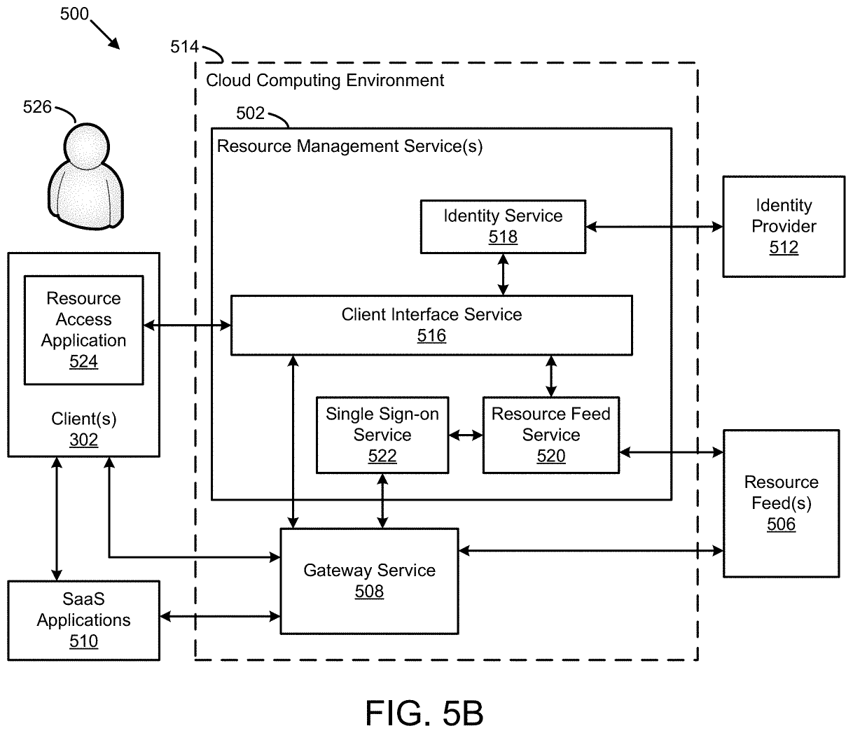

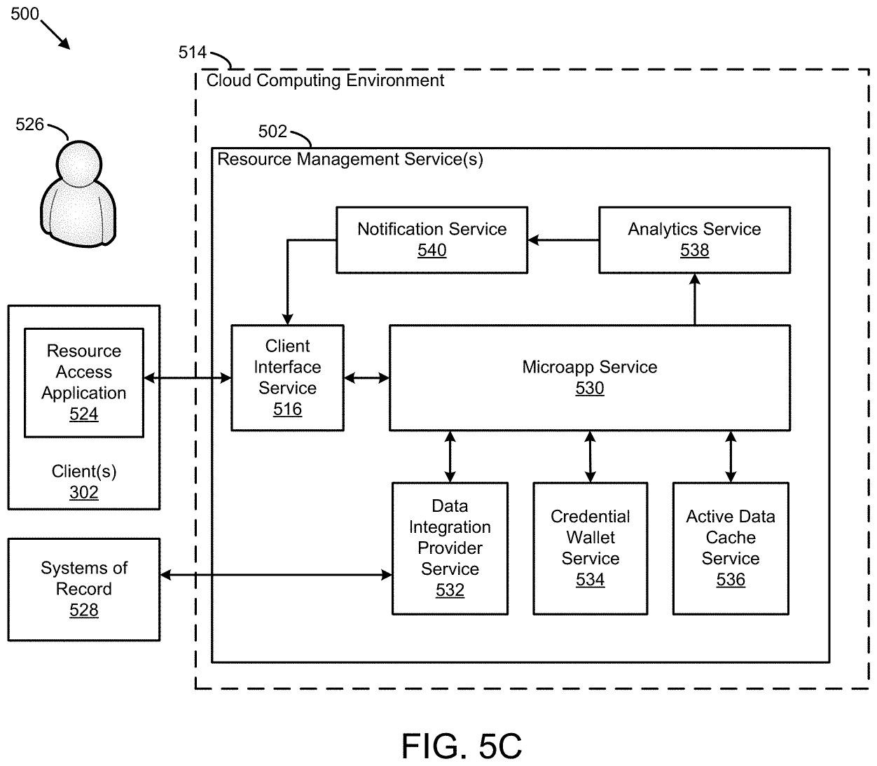

FIG. 5A is a block diagram of an example system 500 in which one or more resource management services 502 can manage and streamline access by one or more clients 302 to one or more resource feeds 506 (via one or more gateway services 508) and/or one or more SaaS applications 510. In particular, the resource management service(s) 502 can employ an identity provider 512 to authenticate the identity of a user of a client 302 and, following authentication, identify one of more resources the user is authorized to access. In response to the user selecting one of the identified resources, the resource management service(s) 502 can send appropriate access credentials to the requesting client 302, and the client 302 can then use those credentials to access the selected resource. For the resource feed(s) 506, the client 302 can use the supplied credentials to access the selected resource via a gateway service 508. For the SaaS application(s) 510, the client 302 can use the credentials to access the selected application directly.

The client(s) 302 can be any type of computing devices capable of accessing the resource feed(s) 506 and/or the SaaS application(s) 510, and can, for example, include a variety of desktop or laptop computers, smartphones, tablets, etc. The resource feed(s) 506 can include any of numerous resource types and can be provided from any of numerous locations. In some implementations, for example, the resource feed(s) 506 can include one or more systems or services for providing virtual applications and/or desktops to the client(s) 302, one or more file repositories and/or file sharing systems, one or more secure browser services, one or more access control services for the SaaS applications 510, one or more management services for local applications on the client(s) 302, one or more internet enabled devices or sensors, etc. Each of the resource management service(s) 502, the resource feed(s) 506, the gateway service(s) 508, the SaaS application(s) 510, and the identity provider 512 can be located within an on-premises data center of an organization for which the system 500 is deployed, within one or more cloud computing environments, or elsewhere.

FIG. 5B is a block diagram showing an example implementation of the system 500 shown in FIG. 5A in which various resource management services 502 as well as a gateway service 508 are located within a cloud computing environment 514. The cloud computing environment can, for example, include Microsoft Azure Cloud, Amazon Web Services, Google Cloud, or IBM Cloud.

For any of illustrated components (other than the client 302) that are not based within the cloud computing environment 514, cloud connectors (not shown in FIG. 5B) can be used to interface those components with the cloud computing environment 514. Such cloud connectors can, for example, run on Windows Server instances hosted in resource locations and can create a reverse proxy to route traffic between the site(s) and the cloud computing environment 514. In the illustrated example, the cloud-based resource management services 502 include a client interface service 516, an identity service 518, a resource feed service 520, and a single sign-on service 522. As shown, in some examples, the client 302 can use a resource access application 524 to communicate with the client interface service 516 as well as to present a user interface on the client 302 that a user 526 can operate to access the resource feed(s) 506 and/or the SaaS application(s) 510. The resource access application 524 can either be installed on the client 302, or can be executed by the client interface service 516 (or elsewhere in the system 500), and accessed using a web browser (not shown in FIG. 5B) on the client 302.

As explained in more detail below, in some examples, the resource access application 524 and associated components can provide the user 526 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 524 is launched or otherwise accessed by the user 526, the client interface service 516 can send a sign-on request to the identity service 518. In some implementations, the identity provider 512 can be located on the premises of the organization for which the system 500 is deployed. The identity provider 512 can, for example, correspond to an on-premises Windows Active Directory. In such examples, the identity provider 512 can be connected to the cloud-based identity service 518 using a cloud connector (not shown in FIG. 5B), as described above. Upon receiving a sign-on request, the identity service 518 can cause the resource access application 524 (via the client interface service 516) to prompt the user 526 for the user's authentication credentials (e.g., user-name and password). Upon receiving the user's authentication credentials, the client interface service 516 can pass the credentials along to the identity service 518, and the identity service 518 can, in turn, forward them to the identity provider 512 for authentication, for example, by comparing them against an Active Directory domain. Once the identity service 518 receives confirmation from the identity provider 512 that the user's identity has been properly authenticated, the client interface service 516 can send a request to the resource feed service 520 for a list of subscribed resources for the user 526.

In other examples (not illustrated in FIG. 5B), the identity provider 512 can be a cloud-based identity service, such as a Microsoft Azure Active Directory. In such implementations, upon receiving a sign-on request from the client interface service 516, the identity service 518 can, via the client interface service 516, cause the client 302 to be redirected to the cloud-based identity service to complete an authentication process. The cloud-based identity service can then cause the client 302 to prompt the user 526 to enter the user's authentication credentials. Upon determining the user's identity has been properly authenticated, the cloud-based identity service can send a message to the resource access application 524 indicating the authentication attempt was successful, and the resource access application 524 can then inform the client interface service 516 of the successfully authentication. Once the identity service 518 receives confirmation from the client interface service 516 that the user's identity has been properly authenticated, the client interface service 516 can send a request to the resource feed service 520 for a list of subscribed resources for the user 526.

For each configured resource feed, the resource feed service 520 can request an identity token from the single sign-on service 522. The resource feed service 520 can then pass the feed-specific identity tokens it receives to the points of authentication for the respective resource feeds 506. Each resource feed 506 can then respond with a list of resources configured for the respective identity. The resource feed service 520 can then aggregate all items from the different feeds and forward them to the client interface service 516, which can cause the resource access application 524 to present a list of available resources on a user interface of the client 302. The list of available resources can, for example, be presented on the user interface of the client 302 as a set of selectable icons or other elements corresponding to accessible resources. The resources so identified can, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 302, and/or one or more SaaS applications 510 to which the user 526 has subscribed. The lists of local applications and the SaaS applications 510 can, for example, be supplied by resource feeds 506 for respective services that manage which such applications are to be made available to the user 526 via the resource access application 524. Examples of SaaS applications 510 that can be managed and accessed as described herein include Microsoft Office 365 applications, SAP SaaS applications, Workday applications, etc.

For resources other than local applications and the SaaS application(s) 510, upon the user 526 selecting one of the listed available resources, the resource access application 524 can cause the client interface service 516 to forward a request for the specified resource to the resource feed service 520. In response to receiving such a request, the resource feed service 520 can request an identity token for the corresponding feed from the single sign-on service 522. The resource feed service 520 can then pass the identity token received from the single sign-on service 522 to the client interface service 516 where a launch ticket for the resource can be generated and sent to the resource access application 524. Upon receiving the launch ticket, the resource access application 524 can initiate a secure session to the gateway service 508 and present the launch ticket. When the gateway service 508 is presented with the launch ticket, it can initiate a secure session to the appropriate resource feed and present the identity token to that feed to seamlessly authenticate the user 526. Once the session initializes, the client 302 can proceed to access the selected resource.

When the user 526 selects a local application, the resource access application 524 can cause the selected local application to launch on the client 302. When the user 526 selects a SaaS application 510, the resource access application 524 can cause the client interface service 516 request a one-time URL from the gateway service 508 as well a preferred browser for use in accessing the SaaS application 510. After the gateway service 508 returns the one-time URL and identifies the preferred browser, the client interface service 516 can pass that information along to the resource access application 524. The client 302 can then launch the identified browser and initiate a connection to the gateway service 508. The gateway service 508 can then request an assertion from the single sign-on service 522. Upon receiving the assertion, the gateway service 508 can cause the identified browser on the client 302 to be redirected to the logon page for identified SaaS application 510 and present the assertion. The SaaS can then contact the gateway service 508 to validate the assertion and authenticate the user 526. Once the user has been authenticated, communication can occur directly between the identified browser and the selected SaaS application 510, thus allowing the user 526 to use the client 302 to access the selected SaaS application 510.

In some examples, the preferred browser identified by the gateway service 508 can be a specialized browser embedded in the resource access application 524 (when the resource application is installed on the client 302) or provided by one of the resource feeds 506 (when the resource application 524 is located remotely), e.g., via a secure browser service. In such examples, the SaaS applications 510 can incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 302 such that the watermark will appear as displayed on the screen if the user tries to print or take a screenshot. Further, in some implementations, when a user selects a hyperlink within a SaaS application, the specialized browser can send the URL for the link to an access control service (e.g., implemented as one of the resource feed(s) 506) for assessment of its security risk by a web filtering service. For approved URLs, the specialized browser can be permitted to access the link. For suspicious links, however, the web filtering service can have the client interface service 516 send the link to a secure browser service, which can start a new virtual browser session with the client 302, and thus allow the user to access the potentially harmful linked content in a safe environment.

In some examples, in addition to or in lieu of providing the user 526 with a list of resources that are available to be accessed individually, as described above, the user 526 can instead be permitted to choose to access a streamlined feed of event notifications and/or available actions that can be taken with respect to events that are automatically detected with respect to one or more of the resources. This streamlined resource activity feed, which can be customized for each user 526, can allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed can be accompanied by a discrete set of user-interface elements, e.g., “approve,” “deny,” and “see more detail” buttons, allowing a user to take one or more simple actions with respect to each event right within the user's feed. In some implementations, such a streamlined, intelligent resource activity feed can be enabled by one or more micro-applications, or “microapps,” that can interface with underlying associated resources using APIs or the like. The responsive actions can be user-initiated activities that are taken within the microapps and that provide inputs to the underlying applications through the API or other interface. The actions a user performs within the microapp can, for example, be designed to address specific common problems and use cases quickly and easily, adding to increased user productivity (e.g., request personal time off, submit a help desk ticket, etc.). In some examples, notifications from such event-driven microapps can additionally or alternatively be pushed to clients 302 to notify a user 526 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 528 labeled “systems of record,” and further in which several different services are included within the resource management services block 502. As explained below, the services shown in FIG. 5C can enable the provision of a streamlined resource activity feed and/or notification process for a client 302. In the example shown, in addition to the client interface service 516 discussed above, the illustrated services include a microapp service 530, a data integration provider service 532, a credential wallet service 534, an active data cache service 536, an analytics service 538, and a notification service 540. In various implementations, the services shown in FIG. 5C can be employed either in addition to or instead of the different services shown in FIG. 5B.

In some examples, a microapp can be a single use case made available to users to streamline functionality from complex enterprise applications. Microapps can, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps can streamline routine tasks for frequently performed actions and provide users the ability to perform actions within the resource access application 524 without having to launch the native application. The system shown in FIG. 5C can, for example, aggregate relevant notifications, tasks, and insights, and thereby give the user 526 a dynamic productivity tool. In some implementations, the resource activity feed can be intelligently populated by utilizing machine learning and artificial intelligence (AI) algorithms. Further, in some implementations, microapps can be configured within the cloud computing environment 514, thus giving administrators a powerful tool to create more productive workflows, without the need for additional infrastructure. Whether pushed to a user or initiated by a user, microapps can provide short cuts that simplify and streamline key tasks that would otherwise require opening full enterprise applications. In some examples, out-of-the-box templates can allow administrators with API account permissions to build microapp solutions targeted for their needs. Administrators can also, in some implementations, be provided with the tools they need to build custom microapps.

Referring to FIG. 5C, the systems of record 528 can represent the applications and/or other resources the resource management services 502 can interact with to create microapps. These resources can be SaaS applications, legacy applications, or homegrown applications, and can be hosted on-premises or within a cloud computing environment. Connectors with out-of-the-box templates for several applications can be provided and integration with other applications can additionally or alternatively be configured through a microapp page builder. Such a microapp page builder can, for example, connect to legacy, on-premises, and SaaS systems by creating streamlined user workflows via microapp actions. The resource management services 502, and in particular the data integration provider service 532, can, for example, support REST API, JSON, OData-JSON, and 6ML. As explained in more detail below, the data integration provider service 532 can also write back to the systems of record, for example, using OAuth2 or a service account.

In some examples, the microapp service 530 can be a single-tenant service responsible for creating the microapps. The microapp service 530 can send raw events, pulled from the systems of record 528, to the analytics service 538 for processing. The microapp service can, for example, periodically pull active data from the systems of record 528.

In some examples, the active data cache service 536 can be single-tenant and can store all configuration information and microapp data. It can, for example, utilize a pertinent database encryption key and per-tenant database credentials.

In some examples, the credential wallet service 534 can store encrypted service credentials for the systems of record 528 and user OAuth2 tokens.

In some examples, the data integration provider service 532 can interact with the systems of record 528 to decrypt end-user credentials and write back actions to the systems of record 528 under the identity of the end-user. The write-back actions can, for example, utilize a user's actual account to ensure all actions performed are compliant with data policies of the application or other resource being interacted with.

In some examples, the analytics service 538 can process the raw events received from the microapps service 530 to create targeted scored notifications and send such notifications to the notification service 540.

Finally, in some examples, the notification service 540 can process any notifications it receives from the analytics service 538. In some implementations, the notification service 540 can store the notifications in a database to be later served in a notification feed. In other implementations, the notification service 540 can additionally or alternatively send the notifications out immediately to the client 302 as a push notification to the user 526.

In some implementations, a process for synchronizing with the systems of record 528 and generating notifications can operate as follows. The microapp service 530 can retrieve encrypted service account credentials for the systems of record 528 from the credential wallet service 534 and request a sync with the data integration provider service 532. The data integration provider service 532 can then decrypt the service account credentials and use those credentials to retrieve data from the systems of record 528. The data integration provider service 532 can then stream the retrieved data to the microapp service 530. The microapp service 530 can store the received systems of record data in the active data cache service 536 and also send raw events to the analytics service 538. The analytics service 538 can create targeted scored notifications and send such notifications to the notification service 540. The notification service 540 can store the notifications in a database to be later served in a notification feed and/or can send the notifications out immediately to the client 302 as a push notification to the user 526.

In some implementations, a process for processing a user-initiated action via a microapp can operate as follows. The client 302 can receive data from the microapp service 530 (via the client interface service 516) to render information corresponding to the microapp. The microapp service 530 can receive data from the active data cache service 536 to support that rendering. The user 526 can invoke an action from the microapp, causing the resource access application 524 to send that action to the microapp service 530 (via the client interface service 516). The microapp service 530 can then retrieve from the credential wallet service 534 an encrypted Oauth2 token for the system of record for which the action is to be invoked and can send the action to the data integration provider service 532 together with the encrypted Oath2 token. The data integration provider service 532 can then decrypt the Oath2 token and write the action to the appropriate system of record under the identity of the user 526. The data integration provider service 532 can then read back changed data from the written-to system of record and send that changed data to the microapp service 530. The microapp service 532 can then update the active data cache service 536 with the updated data and cause a message to be sent to the resource access application 524 (via the client interface service 516) notifying the user 526 that the action was successfully completed.

In some examples, in addition to or in lieu of the functionality described above, the resource management services 502 can provide users the ability to search for relevant information across all files and applications. A simple keyword search can, for example, be used to find application resources, SaaS applications, desktops, files, etc. This functionality can enhance user productivity and efficiency as application and data sprawl is prevalent across all organizations.

In other examples, in addition to or in lieu of the functionality described above, the resource management services 502 can enable virtual assistance functionality that allows users to remain productive and take quick actions. Users can, for example, interact with the “Virtual Assistant” and ask questions such as “What is Bob Smith's phone number?” or “What absences are pending my approval?” The resource management services 502 can, for example, parse these requests and respond because they are integrated with multiple systems on the backend. In some implementations, users can be able to interact with the virtual assistance through either the resource access application 524 or directly from another resource, such as Microsoft Teams. This feature can allow employees to work efficiently, stay organized, and deliver only the specific information being sought.

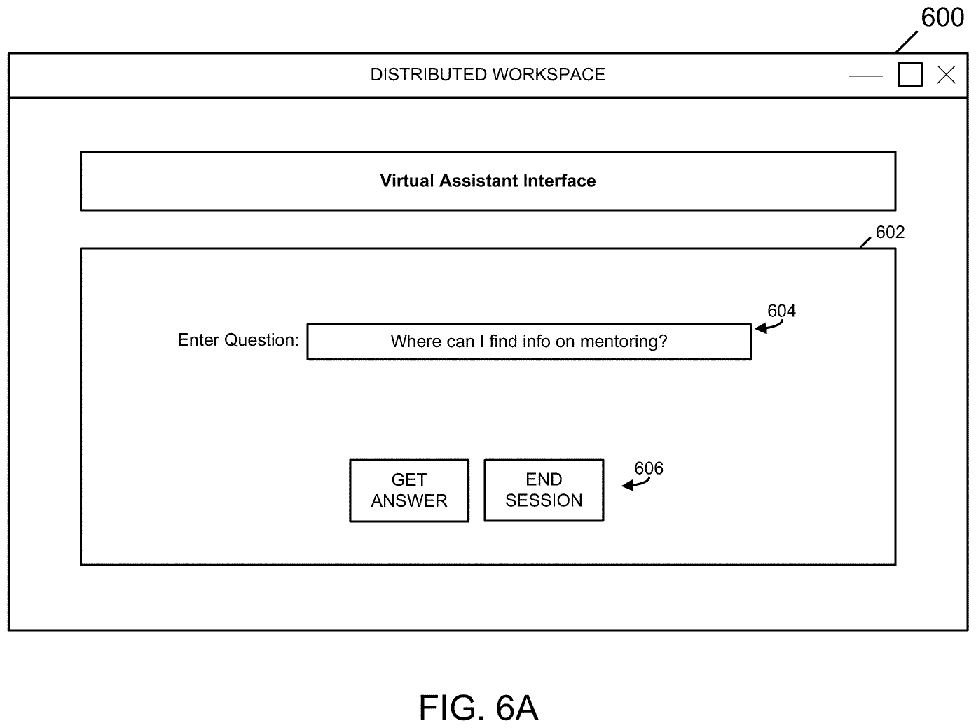

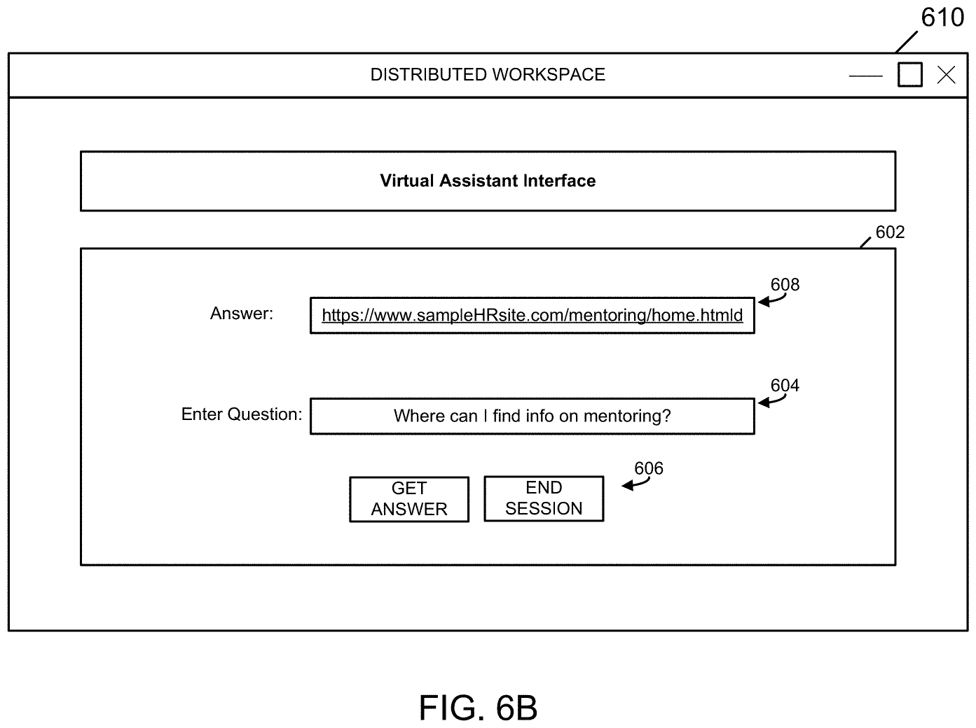

As described herein, user requests entered via a virtual assistant can be implemented using a virtual assistant interface such as interface 106 as shown in FIG. 1 and described above. The interface can be implemented as a user accessible control in, for example, a distributed workspace. For example, FIG. 6A illustrates a sample view of a user interface screen 600 that is displayed on a client computing device such as computing device 102 as shown in FIG. 1 and described above and displayed by a workspace application such as, for example, workspace application 104.

As illustrated in FIG. 6A, the screen 600 includes user interface controls 602, 604, and 606 associated with a virtual assistant interface such as virtual assistant interface 106 as shown in FIG. 1 and described above. In certain implementations, the control 602 can be configured to display a user-interactive portion of the virtual assistant interface being displayed in screen 600. For example, as shown in FIG. 3A, the control 602 can include controls 604 and 606. Control 604 can include a text box that the user can enter a query and/or response into. The user can type directly into control 604 using an input device such as a keyboard. In some examples, the control 604 can include a drop down menu or other similarly pre-populated control that includes a list of, for example, commonly asked questions for a specific application. The control 606 can include an option for the user to submit the request and get an answer or to end the virtual assistant session.

FIG. 6B illustrates a sample screenshot 610 of an answer received from a virtual assistant monitor such as virtual assistant monitor 114 as shown in FIG. 1 and described above. As shown in FIG. 6B, control 602 can further include control 608 that includes a response to the previously submitted virtual assistant request. As shown in FIG. 6B, the control 608 can include text formatted as, for example, a link to another page or application that includes additional information related to the submitted virtual assistant request.

It should be noted that the virtual assistant interface is shown as a standalone interface in FIGS. 6A and 6B by way of example only. In certain implementations, the virtual assistant interface can be integrated directly into an application (e.g., on the side of an application window or under a title bar of the application window) to provide easier user access to the virtual assistant.

### Sample Implementation Processes

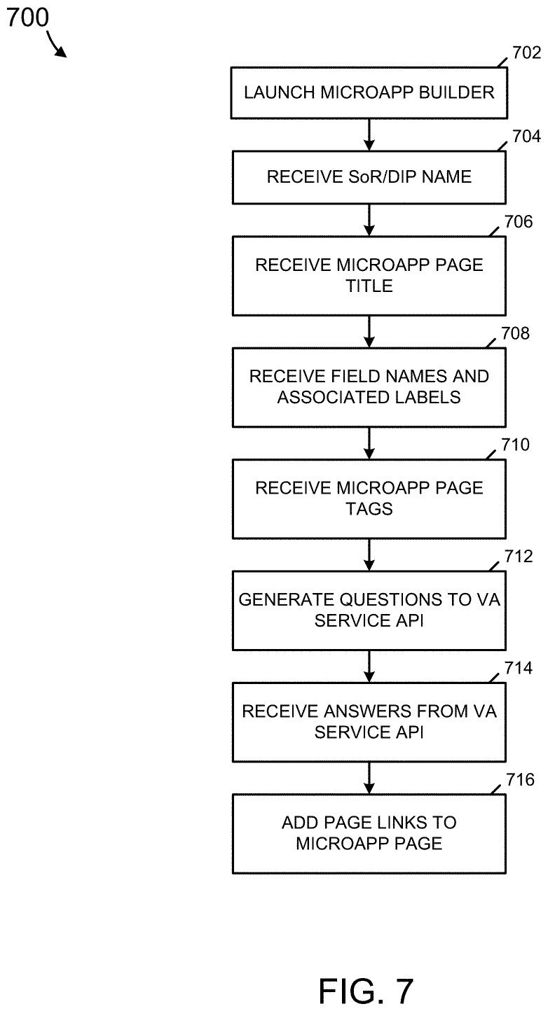

As noted above, a user of a microapp may want to request additional information that is beyond the scope of the microapp and may not be defined or otherwise provided in data associated with the microapp. When designing a microapp, the designer and/or admin associated with the microapp may have the option to provide various data related to the operation of the microapp. However, this data may be limited to the knowledge of the designer/admin and the available information contained within the microapp. As described herein, the designer/admin can use a recommendation system when building a microapp that automatically processes microapp page data and generates, for example, a knowledge base data structure for the microapp page as described herein. In certain implementations, the knowledge base data structure can be implemented as a question and answer model or a set of results from a language modeling process that are configured to provide a knowledge base for identifying answers to user-submitted requests. For example, the information contained in an example knowledge base data structure as generated by the process illustrates in FIG. 7 and described below may provide an answer to a user-submitted request or, in certain implementations, provide additional information to supplement information obtained from another source. As further described herein below, the knowledge base data structure can be accessed in response to a user-submitted request and searched for an answer using, for example, keyword matching, language modeling, and other similar text-based analysis and searching techniques. In some examples, as a user is inserting or otherwise adding fields to a microapp page, the processor can implicitly access or modify the knowledge base data structure based upon information such as the microapp page title. For example, when a user is accessing a microapp page with the title “pay slip” and is adding additional fields, the processor running the microapp UI builder can implicitly send a request such as “what page can I find information about pay slips” and receive one or more answers to the question from the knowledge base data structure. The processor can display the answer in the microapp UI builder for review by the user. In such examples, the recommendation system as described above can be based upon user interactions within the microapp page as well as any user-submitted requests as noted above.

FIG. 7 illustrates a sample process 700 related to assigning one or more data fields to a microapp during creation or updating of a microapp. As shown in FIG. 7, a processor running a microapp service such as microapp service 530 can be configured to launch 702 a microapp builder in response to, for example, a request to create or update a microapp. The processor can further receive 704 a system of record and/or a directory integration platform name for the microapp. This information can help to narrow any recommended links and/or other information associated with the microapp as described herein.

As further shown in FIG. 7, the processor can receive 706 a microapp page title. If the microapp is being newly created, the page title can be newly provided by a designer of the microapp. If the microapp is being updated, the page title can include changes to the existing title as provided by the designer/admin of the microapp. The processor can further receive 708 field names and associated labels for the microapp page. For example, the field names can be associated with text fields, user controls, HTML elements, links, and other similar features inserted into the microapp by the designer. The processor can also receive 710 one or more microapp page tags. The page tags can be provided by, for example, the designer/admin and can be used to categorize the microapp. For example, if the microapp is configured to provide a user with access to a pay slip as stored in a human resources pay tracking application, the microapp can include the page tag “pay slip.”

As further shown in FIG. 7, based upon the field names and/or page tag information, the processor can generate 712 a set of basic questions to use when calling an API such as a virtual assistant API. The processor can be configured to use a natural language processor to generate a set of questions based upon the microapp page details as described above. In certain implementations, the processor can use a template or other similar framework to generate a question using keywords identified from the field names and page tag information. In other examples, the processor can use a language modeling process to generate questions based upon the field names and page tag information. For example, if the page tag is “pay slip,” the processor can identify various words and their associated classes in the page tag information such as nouns and verbs and assign, in some examples, a token type to the identified word(s). To continue the above example, if the page tag is “pay slip,” the phrase “pay slip” can be identified as a noun. Based upon the identification of words contained within the field names and page tag information, the processor can generate questions such as “where can I find my current pay slip?”, “where can I find past pay slips?”, and other similar questions. If the virtual assistant API can provide additional information related to the generated questions, the processor can receive 714 answers from the API and present information related to the answers to the designer/admin. Based upon feedback received from the designer/admin, the processor can add 716 one or more page links to the microapp page. In certain implementations, the processor can display information to be included in the knowledge base data structure to the designer/admin of the microapp page in, for example, a recommendation user interface. The designer/admin can access the displayed information and indicate what portion is to be included in the microapp page data using, for example, a drag and drop or other similar input technique. As such, using a repeated implementation of at least a portion of the process 700 as shown in FIG. 7, the microapp page data can be regularly updated to reflect changes to the microapp or the associated web/SaaS application(s).

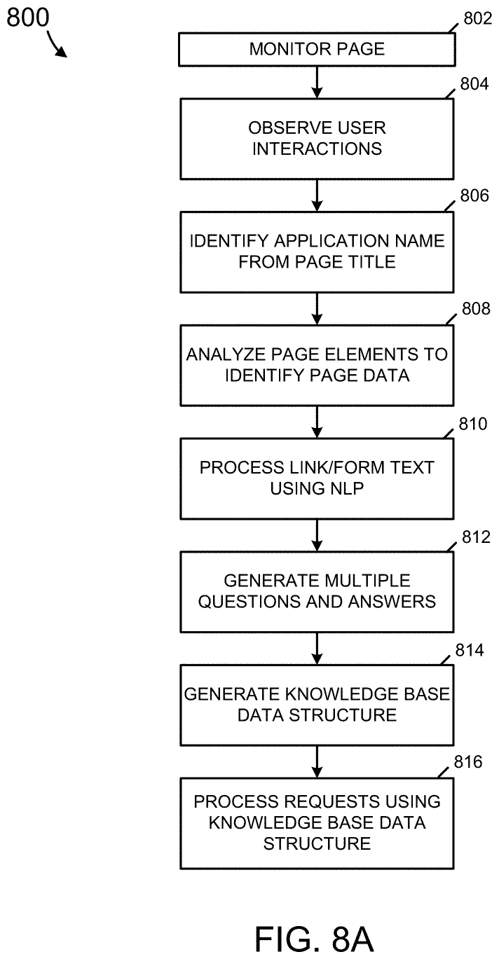

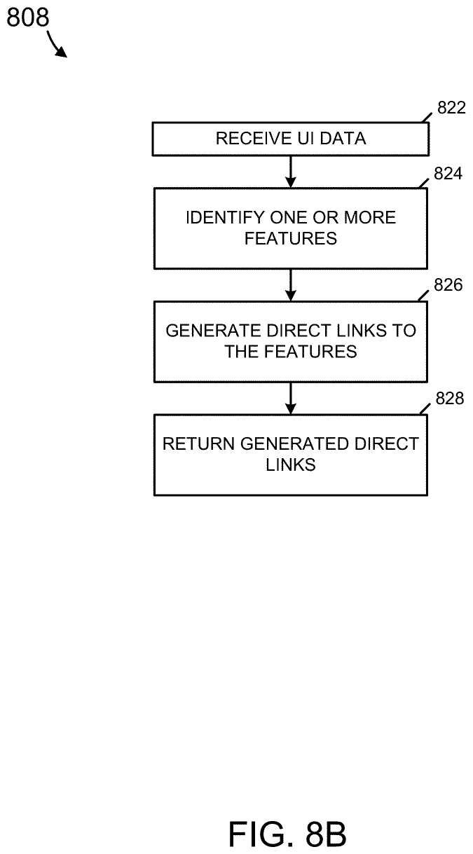

While the process 700 as shown in FIG. 7 can generate a knowledge base data structure including answers to potential user requests submitted via a virtual assistant, the answers are limited to the links and/or other information that was associated with the microapp page when the page was created and/or updated. FIGS. 8A and 8B illustrate sample processes for generating a knowledge base data structure for use when answering user-submitted requests to a virtual assistant as described herein.

As shown in FIG. 8A, process 800 includes monitoring user interactions with a web/SaaS application and updating a knowledge base data structure to provide additional information related to the application such as, for example, links to one or more associated microapps as described herein. As shown in FIG. 8A, a processor running a monitoring process such as an event handler can monitor 802 a page associated with an application in a distributed workspace environment such as those described herein. The processor can use the monitoring process to observe 804 user interactions with the application including, for example, user clicks, user-provided text, user navigation between pages of the application, and other similar interactions. Additionally, the processor can identify 806 the name of the application that the user is interacting with. For example, the name can be identified based upon the title of the page the user is interacting with, information contained in a URL of the page the user is interacting with, and other similar information.

Based upon the monitoring user interactions and page titles, the processor can analyze 808 page elements within the application to identify links between application pages as well as forms, headers, labels, paragraphs, and other similar data contained in the application pages that may include additional related information. Additional detail related to identifying links between application pages can be found in U.S. patent application Ser. No. 16/940,482 (the '482 application), filed Jul. 28, 2020, and titled “Direct Linking Within Applications.” FIG. 8B illustrates a sample process for identifying links between application pages, summarizing FIG. 6 and the associated description from the '482 application.

As shown in FIG. 8B, a processor can receive 822 UI data from one or more client devices. The UI data may include data collected by the one or more client devices during a plurality of user sessions for an app. The plurality of user sessions may include sessions for a single user or sessions for multiple different users. The processor can analyze 824 the UI data to identify one or more features of the app. In some embodiments, a user can manually identify features of interest (e.g., by providing an input on corresponding UI elements within the app).

As further shown in FIG. 8B, the processor can generate direct links for one or more of the identified application features. The processor can return 828 the generated links to one or more users of the app. In some embodiments, this can include sending the direct links to a resource access application installed on client devices. In some embodiments, direct links can be published to a search engine, or other repository, accessible by the resource access application. When the user clicks on a direct link, the direct link can interact with the one or more UI elements to navigate to the corresponding application feature. In some embodiments, this can include executing a sequence of steps (e.g., a sequence of JavaScript instructions) to navigate to the application feature. In some implementations, a direct link may navigate to the application feature without display of other portions of the application that do not include the feature. For example, the direct link steps can include hiding/removing UI elements on the page that are not part of the feature.

Referring again to FIG. 8A, the processor can further process 810 the returned links and form and other page data using, for example, a natural language processor. For example, the processor can use a transformer-based machine learning natural language processor such as the BERT model developed by Google. Based upon the processed links and form and page data, the processor can identify one or more keywords associated with the application and generate 812 multiple questions and answers associated with the keywords. More specifically, the language model can be trained on the identified one or more keywords to create paragraph and/or text content. For example, a paragraph can include the text “the information related to pay slips can be found at [direct link]. You can also find information related to benefits at [direct link 2].” Based upon processing and training using such text, the language model be configured to process incoming user-submitted queries to provide answers based upon the processed data. For example, the language model can be trained to response to a user-submitted request of “where can I find information about my pay slip” with the answer [direct link].

The processor can also generate 812 the questions and answers by processing and parsing the text included in the form and page data to create question and answer pairs. For example, the paragraph as described above can include the text “the information related to pay slips can be found at [direct link]. You can also find information related to benefits at [direct link 2].” Based upon such text, the processor can parse and process the text to generate a question/answer pair including the question “where can I find information about pay slips” having an associated answer of [direct link]. Similarly, the processor can parse and process the text to generate a second question/answer pair including the question “where can I find information about benefits” having an associated answer [direct link 2]. However, it should be noted that parsing and processing the text from a language model is provided by way of example only. In some implementations, the processor can generate 812 the questions and answers directly from form and page data as described herein without further processing by a language model.

As further shown in FIG. 8A, the processor can further generate 814 and store a knowledge base data structure including a combination of the trained language model, the identified keywords, the generated questions, and/or the associated answers on a storage device such as datastore 116 as shown in FIG. 1 and described above. The processor can further process 816, answer, or otherwise respond to user-submitted requests using the knowledge base data structure. For example, if the knowledge base data structure includes a language model, the processor can process 816 any incoming user-submitted requests using the language model to generate a response to the request. In examples there the knowledge base data structure includes a question and answer listing, the processor can process 816 an incoming user-submitted request by parsing the request to determine if a similar question is contained within the knowledge base data structure. If the processor does determine that a similar question is contained Within the knowledge based data structure, the processor can identify an answer associated with the identified question and respond to the user-submitted request accordingly. Additional information related to answering user-submitted requests is provided in FIG. 10 and the associated description below.

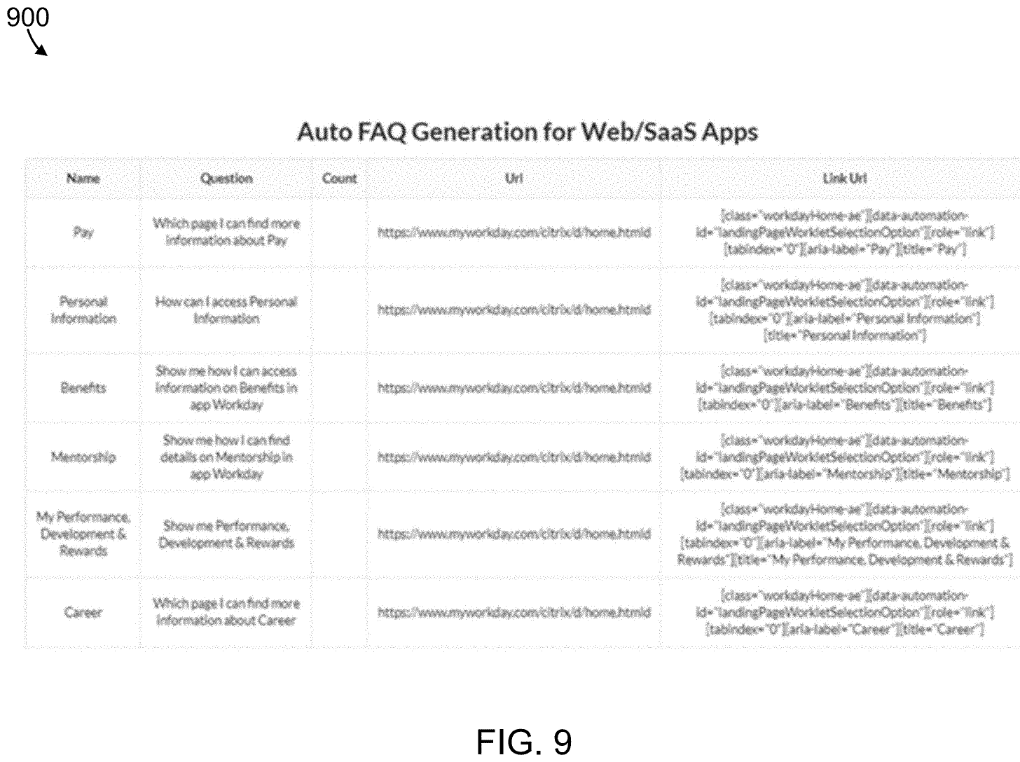

FIG. 9 illustrates a sample knowledge base data structure 900 generating using, for example, a similar process as that shown in FIGS. 8A and 8B. As shown in FIG. 9, the data structure 900 can be formatted as a two-dimensional structure where each individual row is related to a particular name or keyword. Each row includes additional information related to the keyword such as related questions generated, for example, as described above in the discussion of FIG. 8A, count information (e.g., how often has this question been asked by a user as well as feedback information such as how reliable do user's consider an associated response), a URL associated with the answer to the generated question, and link URL information. It should be noted that the information as shown in FIG. 9 is provided by way of example only and, in actual implementation, the information contained in a knowledge base data structure as described herein can vary accordingly.

In some examples, an auto-generated knowledge base data structure such as that described above can function as an intermediate data structure which is fed into an actual model, such as a question and answer model, for training purposes. The output of the actual model can be a trained model that can then be used to answer any user-submitted questions. In such an example, a knowledge base data structure such as structure 900 as shown in FIG. 9 would not be used as-is, rather, the structure 900 would be further used to train a question and answer model as described herein. For example, a web element “mentorship” can have various associated synonyms such as “mentor” and “mentoring” than can be autogenerated during creation or updating of the knowledge base data structure. For all such synonyms, there can be a new question and answer entry in the knowledge base data structure or a sentence of two in the language paragraph being used to train the language model as described herein. In such an example, all of the synonyms will have the same answer pointing to the same direct link in the output of the trained model. In this way, processing a user-submitted request is not restricted to a keyword-based match but more to a semantic search across associated web/SaaS application(s) based upon web/HTML/UI elements as described herein.

FIG. 10 illustrates a sample process 1000 for answering a user-submitted request via a virtual assistant as described herein. For example, the process 1000 can be implemented by a processor running a virtual assistant monitor such as virtual assistant monitor 114 as shown in FIG. 1 and described above.

As shown in FIG. 10, the processor can receive 1002 a user-submitted request received from a virtual assistant running on a client device (e.g., virtual assistant interface 106 as shown in FIG. 1 and described above). The processor can process 1004 the request to generate one or more characteristics associated with the request. In certain implementations, the processor can parse the request and identify one or more keywords contained in the request. For example, the processor can use a natural language processor to identify one or more nouns and verbs in the request. Based upon the processed keywords, the processor can determine 1006 if an answer to the user-submitter request is contained in the application page data (e.g., the data as described above in discussion of FIG. 7 and associated with, for example, w web/SaaS application). For example, the processor can compare identified keywords in the request to the one or more page tags and field names associated with the application page as described above. If there is a match, the processor can identify one or more answers to the request associated with the matching keywords.

If an answer to the request is contained in the application page data, the processor can format and provide 1008 a response to the user of the client device. Conversely, if the processor determines 1006 that there is no appropriate answer to the request in the application page data, the processor can determine 1010 if there is an appropriate response to the user-submitted request in the knowledge base data structure (e.g., the data structure as constructed in FIGS. 8A and 8B and shown in FIG. 9, each of which are described above). In an example, the processor can perform a keyword comparison between identified keywords in the request and one or more named keywords as contained in the knowledge base data structure. If an answer to the request is contained in the knowledge base data structure, the processor can identify the answer information (e.g., a link or other similar URL information), format a response, and provide 1008 the response to the user of the client device. In another example, the processor can parse the user-submitted request to determine one or more questions contained within the request. If the processor identifies a question in the request, the processor can access the knowledge based data structure to determine if a similar question is included in this structure. If a similar question is identified in the knowledge base data structure, the processor can determine an answer associated with the identified question. The processor can further provide 1008 a response based upon the determined answer to the user of the client device. In certain implementations, the processor can access a language model as described here in to process the user-submitted request. The process can input the user-submitted request into the language model, the language model can parse and/or process the user-submitted request and generate an answer to the request as described herein. The processor can then provide 1008 a response to the user-submitted request based upon the output of the language model.

In some examples, the output of the language model can include multiple answers, each having an associated score generated during the model process. The output answers can be ranked, by example, from answers having the highest score to answers having the lowest score. In such an example, the virtual assistant processing and displaying the result can format and display one or more of the ranked answers to the user for selection and, based upon receiving an indication of a user selection, can trigger at least one direct link in response to the user selection.

If, however, the processor does not determine 1010 that there is an appropriate response to the request in the knowledge base data structure, the process can make one or more API calls using the identified keywords to determine 1012 if there is any information in the related APIs that can be provided to the user of the client device. If the processor does determine 1012 that there is information that can be provided to the user of the client device in the API response, the processor can format the information and provide 1008 a response to the user of the client device. Conversely, if the processor determines 1012 that there is no information in the related APIs that can be provided to the user, the processor can provide 1014 an indication of no response to the user of the client device.

It should be noted that, in some examples, a combination of models can be used to determine an appropriate response to a request as described herein. For example, both a natural language processing model (e.g., the BERT model as described above) as well as question and answer model as described above can be used to process a specific user request and the outputs of both models can be combined. For example, if a particular model such as the natural language processing model does not generate an answer, but the question and answer model performs well and produces a set of output, the combined output set should provide one or more responses to the user-submitted request. In some examples, depending upon the number of available and trained models, more than two models can be used to process a user request and generate a response as described above.

It should also be noted that the processes 700, 800, and 1000 as shown in FIGS. 7, 8A, 8B, and 10 are provided by way of example only. It should also be noted that the specific process flow, and the order of sequence steps associated with the process flows as described herein, are provided by way of example only. Various steps contained within the process flows as described herein can be altered, reordered, or otherwise omitted depending upon the implementation of the techniques as described herein.

### Hardware Implementation Examples

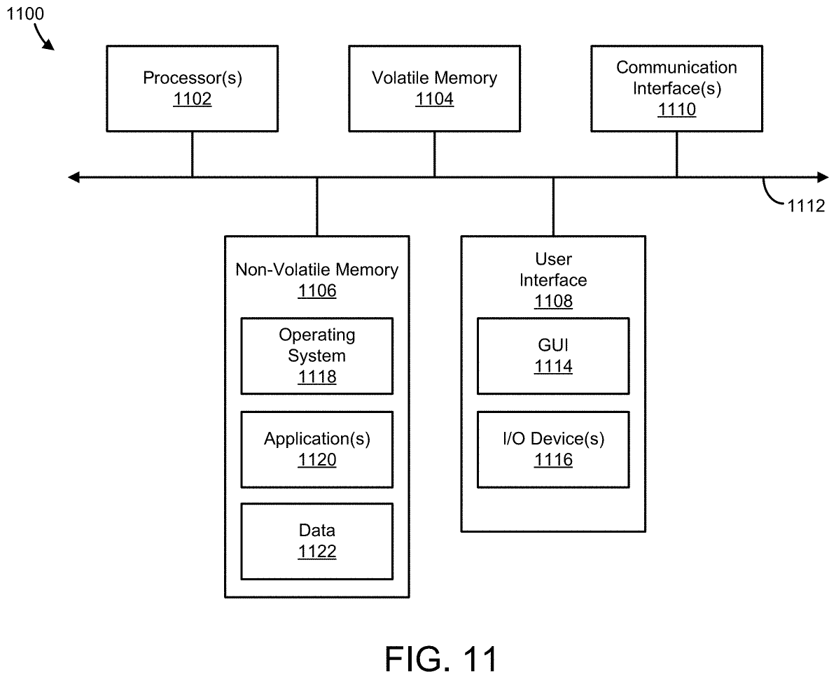

FIG. 11 depicts a block diagram of a computing device 1100 useful for practicing an example of client device 102 and/or workspace host device 110 as shown in FIG. 1 and described above. The computing device 1100 includes one or more processors 1102, volatile memory 1104 (e.g., random access memory (RAM)), non-volatile memory 1106, UI 1108, one or more communications interfaces 1110, and a communications bus 1112. One or more of the computing devices 1100 can also be referred to as a computer system.

The non-volatile memory 1106 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 1108 can include a graphical user interface (GUI) 1114 (e.g., a touchscreen, a display, etc.) and one or more input/output (I/O) devices 1116 (e.g., a mouse, a keyboard, a microphone, one or more speakers, one or more cameras, one or more biometric scanners, one or more environmental sensors, and one or more accelerometers, etc.).

The non-volatile memory 1106 can store an operating system 1118, one or more applications 1120, and data 1122 such that, for example, computer instructions of the operating system 1118 and/or the applications 1120 are executed by processor(s) 1102 out of the volatile memory 1104. In some examples, the volatile memory 1104 can include one or more types of RAM and/or a cache memory that can offer a faster response time than a main memory. Data can be entered using an input device of the GUI 1114 or received from the I/O device(s) 1116. Various elements of the computing device 1100 can communicate via the communications bus 1112.

The illustrated computing device 1100 is shown merely as an example client device or server and can be implemented by any computing or processing environment with any type of machine or set of machines that can have suitable hardware and/or software capable of operating as described herein.

The processor(s) 1102 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 1102 can be analog, digital or mixed. In some examples, the processor 1102 can include multiple processor cores and/or multiple processors configured to provide functionality for parallel, simultaneous execution of instructions or for parallel, simultaneous execution of one instruction on more than one piece of data.

The communications interfaces 1110 can include one or more interfaces to enable the computing device 1100 to access a computer network such as a Local Area Network (LAN), a Wide Area Network (WAN), a Personal Area Network (PAN), or the Internet through a variety of wired and/or wireless connections, including cellular connections.

In described examples, the computing device 1100 can execute an application on behalf of a user of a client device (e.g., client device 102 as shown in FIG. 1 and described above). For example, the computing device 1100 can execute one or more virtual machines managed by a hypervisor and accessed via, for example, a client agent. Each virtual machine can provide an execution session within which applications execute on behalf of a user or a client device, such as a hosted desktop session. The computing device 1100 can also execute a terminal services session to provide a distributed workspace environment. The computing device 1100 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A computing device for providing a response to user-submitted requests, the computing device comprising:
a computer readable medium; and
at least one processor operably coupled to the computer readable medium and configured to
receive a user-submitted request for additional information from a client device, the request submitted via a virtual assistant associated with a distributed workspace,
process the user-submitted request to determine one or more user queries,
process the one or more user queries using at least one data set associated with at least one application of the distributed workspace to determine at least one response to the user-submitted request,
generate a reply to the user-submitted request based upon the determined at least one response, the reply generated to include one or more elements related to the determined at least one response, and
transmit the reply to the client device.

2. The computing device of claim 1, wherein the at least one data set comprises one or more of a knowledge base data structure associated with the at least one application of the distributed workspace, a language model trained to process the user-submitted request, and/or a set of information retrieved from one or more application programming interface (API) calls associated with the at least one application of the distributed workspace.

3. The computing device of claim 2, wherein the knowledge base data structure comprises a set of named keywords, each of the set of named keywords having one or more generated questions and at least one response link related to the at least one application of the distributed workspace.

4. The computing device of claim 3, wherein the at least one processor is further configured to:
process the user-submitted request to determine one or more keywords;
compare the one or more keywords to the knowledge base data structure to identify at least one matching set of keywords; and
identify the at least one response link associated with a named keyword in the at least one matching set of keywords and format the response link as the reply to the user-submitted request.

5. The computing device of claim 4, wherein the response link comprises a uniform resource locator (URL) configured to direct a workspace application running on the client device to at least one of a second application or at least one web/SaaS application that provides additional information related to the user-submitted request.

6. The computing device of claim 2, wherein the at least one processor is further configured to update the knowledge base data structure based upon run-time monitoring of user interactions with the distributed workspace.

7. The computing device of claim 6, wherein the at least one processor is further configured to generate and/or update the knowledge base data structure based upon at least designer-provided responses to recommended information to include in the knowledge base data structure as determined by the at least one processor based upon information related to a microapp page and provided to the designer when accessing a microapp user interface builder.

8. The computing device of claim 6, wherein the at least one processor is further configured to auto-generate at least one of a natural language processing model based upon the knowledge base data structure and a question and answer model based upon the knowledge base data structure.

9. The computing device of claim 2, wherein the at least one processor is further configured to:
process the one or more user queries by inputting the one or more user queries to the language model;
receive an output to the one or more user queries from the language model; and
generate the reply to the user-submitted request based upon the output of the language model.

10. A method of providing a response to user-submitted requests, the method comprising:
receiving, by a processor, a user-submitted request for additional information from a client device, the request submitted via a virtual assistant associated with a distributed workspace;
processing, by the processor, the user-submitted request to determine one or more user queries;
processing, by the processor, the one or more user queries using at least one data set associated with at least one application of the distributed workspace to determine at least one response to the user-submitted request;
generating, by the processor, a reply to the user-submitted request based upon the determined at least one response, the reply generated to include one or more elements related to the determined at least one response; and
transmitting, by the processor, the reply to the client device.

11. The method of claim 10, wherein the at least one data set comprises one or more of a knowledge base data structure associated with the at least one application of the distributed workspace, a language model trained to process the user-submitted request, a set of data fields assigned to a microapp associated with the at least one application of the distributed workspace when then microapp was initiated, and/or a set of information retrieved from one or more application programming interface (API) calls associated with the at least one application of the distributed workspace.

12. The method of claim 11, wherein the knowledge base data structure comprises a set of named keywords, each of the set of named keywords having one or more generated questions and at least one response link related to the microapp associated with the at least one application of the distributed workspace.

13. The method of claim 12, further comprising:
processing, by the processor, the user-submitted request to determine one or more keywords;
comparing, by the processor, the one or more keywords to the knowledge base data structure to identify at least one matching set of keywords; and
identifying, by the processor, the at least one response link associated with a named keyword in the at least one matching set of keywords and format the response link as the reply to the user-submitted request.

14. The method of claim 11, wherein the method further comprises:
updating, by the processor, the knowledge base data structure based upon run-time monitoring of user interactions with the distributed workspace; and
auto-generating, by the processor, at least one of a natural language processing model based upon the knowledge base data structure and a question and answer model based upon the knowledge base data structure.

15. The method of claim 11, further comprising:
processing, by the processor, the one or more user queries by inputting the one or more user queries to the language model;
receiving, by the processor, an output to the one or more user queries from the language model; and
generating, by the processor, the reply to the user-submitted request based upon the output of the language model.

16. A non-transitory computer-readable medium storing computer-executable instructions to implement a process of providing a response to user-submitted requests, the instructions comprising instructions to:
receive a user-submitted request for additional information from a client device, the request submitted via a virtual assistant associated with a distributed workspace;
process the user-submitted request to determine one or more user queries;
process the one or more user queries using at least one data set associated with at least one application of the distributed workspace to determine at least one response to the user-submitted request;
generate a reply to the user-submitted request based upon the determined at least one response, the reply generated to include one or more elements related to the determined at least one response; and
transmit the reply to the client device.

17. The non-transitory computer-readable medium of claim 16, wherein the at least one data set comprises one or more of a knowledge base data structure associated with the at least one application of the distributed workspace, a language model trained to process the user-submitted request, and/or a set of information retrieved from one or more application programming interface (API) calls associated with the at least one application of the distributed workspace.

18. The non-transitory computer-readable of claim 17, wherein the knowledge base data structure comprises a set of named keywords, each of the set of named keywords having one or more generated questions and at least one response link related to the at least one application of the distributed workspace.

19. The non-transitory computer-readable of claim 18, further comprising instructions to:
process the user-submitted request to determine one or more keywords;
compare the one or more keywords to the knowledge base data structure to identify at least one matching set of keywords; and
identify the at least one response link associated with a named keyword in the at least one matching set of keywords and format the response link as the reply to the user-submitted request.

20. The non-transitory computer-readable of claim 17, further comprising instructions to:
process the one or more user queries by inputting the one or more user queries to the language model;
receive an output to the one or more user queries from the language model; and
generate the reply to the user-submitted request based upon the output of the language model.
